(19) United States
(12) Patent Application Publication
(10) Pub. No.: US 2019/0320844 A1
(43) Pub. Date: Oct. 24, 2019

(54) GENERATING A COOKING PROCESS

(71) Applicant: V-Zug AG, Zug (CH)

(72) Inventors: Stephan Dieter Keller, Baar (CH); Beat Sidler, Aeugst am Albis (CH)

(73) Assignee: V-Zug AG, Zug (CH)

(21) Appl. No.: 16/315,818

(22) PCT Filed: Jun. 28, 2017
(86) PCT No.: PCT/CH2017/000066

§ 371 Date: Jan. 7, 2019

(30) Foreign Application Priority Data
Jul. 8, 2016 (CH) 0880/16

(51) Int. Cl. A47J 36/32; G06F 16/22; A47J 44/00; A23L 5/10

(52) U.S. Cl. CPC A47J 36/321; G06F 16/22; A23V 2002/00; A23L 5/15; A23L 5/13; A47J 44/00

(57) ABSTRACT

An apparatus comprises at least one cooking device (21-24), in particular a baking oven (22) or a steam-cooking appliance (21), for preparing at least one foodstuff. The apparatus further comprises an input device (3), an output device (4), and a central control unit (1). The central control unit (1) identifies a recipe based upon input parameters specifying the foodstuffs as well as further ingredients and generates a cooking process for the recipe. The recipe is output by means of the output device (4) and the cooking process is transmitted to a cooking process control (26) of the cooking device (21-24).

### CROSS REFERENCES TO RELATED APPLICATIONS

This application is a National Stage application of International Patent Application No. PCT/CH2017/000066, filed on Jun. 28, 2017 which claims priority of Swiss patent application 0880/16, filed 8 Jul. 2016, each of which is incorporated herein by reference in its entirety.

### TECHNICAL FIELD

The invention relates to an apparatus with at least one cooking device, in particular a baking oven, a steam-cooking appliance, a microwave oven, or a combined cooking device, for preparing a foodstuff to be cooked. The invention also relates to a method for operating this type of apparatus.

### BACKGROUND

It has been a known situation where several goods to be cooked are available in a household, in particular in a fridge, by means of which fine food is to be cooked. In other words, food items are to be used that are already in stock in order to avoid having to discard them due to expiry. In this situation, a recipe using as much of the stocked food items as possible is desired. Software solutions have been known for this purpose, which are able to register the stocked foodstuffs and to identify, from a database, one or more suitable recipe(s) using as many of the stocked food items as possible.

### SUMMARY

The problem to be solved is to provide an apparatus and a method of the type mentioned above that simplify the preparation of a meal.

This problem is solved by the subject of the independent claims.

Hence, in a first aspect, the apparatus comprises at least one cooking device, in particular a baking oven, a steam-cooking appliance, a microwave oven, or a combined cooking device, for preparing at least one foodstuff to be cooked.

A “combined cooking device” is a cooking device equipped for several cooking methods. For example, a combined cooking device is able cook a foodstuff simultaneously by means of microwave radiation and steam.

The apparatus further comprises at least one input device for entering input parameters of the foodstuffs as well as further ingredients. Foodstuffs are to be understood as ingredients that are to be cooked by means of the cooking device, such as a beef tenderloin. “Further ingredients” are to be understood as ingredients that are not to be cooked, such as salad.

Entering the input parameters by means of the input device can e.g. occur by means of a user input and/or by means a sensor device, which e.g. accesses input parameters in the cooking cavity, such as the amount of the foodstuff to be cooked by weighing using an electronic scale and/or by means of an algorithm that searches recipes for information and recognizes them as input parameters, e.g. because the foodstuffs and ingredients are mentioned in electronically searchable recipes.

The apparatus also comprises at least one central control unit and at least one output device for outputting information, such as a display.

The at least one control unit and/or the at least one output device and/or the at least one input device can be located externally to the at least one cooking device, or they can be part of the at least one cooking device.

“Arranged externally” means that they are substantially independent devices able to communicate with each other. For example, the entry of the input parameters can be carried out on an external digital device, such as a computer, tablet, or smartphone. An externally arranged output device can e.g. be a display, or the output can occur on a printer onto paper. An externally arranged central control unit can e.g. be a server where computing operations can take place.

Using the input parameters of the foodstuffs and the further ingredients, the at least one central control unit is adapted to
identify a recipe, and
generate a cooking process for the recipe and transmit the same to at least one cooking process control of the at least one cooking device.

A recipe comprises the instructions for preparing a foodstuff and/or a meal.

In particular, it explains how to combine the foodstuffs and the further ingredients, or it describes a sequence of instructions by means of which the foodstuffs and the other ingredients are to be prepared. For example, the recipe can mention that the meat is to be marinated prior to cooking. In other words, the recipe and the cooking process for the recipe advantageously comprise at least partially complementing information that, together, are necessary to prepare a foodstuff to be cooked or a meal.

The cooking process for the recipe therefore defines how the foodstuff is to be cooked and the recipe defines other information that can be used for preparing the foodstuff and/or the meal. The preparation of a foodstuff can e.g. be the preparation of a braided loaf, where the braided loaf comprises, inter alia, the ingredients flour, salt, sugar, yeast, milk, etc.

The advantage of the described apparatus lies in the combination of the recipe and the cooking process. Up to now, a user had a recipe, e.g. from a cookbook, which contained instructions for cooking a given foodstuff. For example, the recipe mentioned that the foodstuff is to be cooked in a baking oven during 30 minutes at 180° C. Hence, a recipe could only offer rudimental instructions for operating a cooking device. On the other hand, conventional cooking devices also contain pre-programmed and complex cooking procedures for individual foodstuffs. The problem consisted in that the user either had to use the simple cooking process from the recipe, or—if he wanted to use a pre-programmed cooking process—he was unsure if the pre-programmed cooking process was suited for preparing the respective recipe.

By means of the described apparatus, a cooking process suited for the recipe can be transmitted to the at least one cooking device by first identifying a recipe from the given input parameters and then generating a cooking process suited for the recipe. The cooking process is therefore generated dynamically and transmitted to the cooking device. Since the cooking process is transmitted to the at least one cooking device, it can comprise complex instructions. The user does not have to take care of the settings of the cooking process.

Advantageously, the transmission of the cooking process to the cooking process control can occur autonomously from the central control unit to the cooking process control, such that no further user action is required for that purpose.

In a preferred embodiment, the input parameters of the at least one foodstuff comprise
the type of the at least one foodstuff and/or
the ingredients of the at least one foodstuff and/or
the amount of the at least one foodstuff, in particular the weight and/or volume and/or count of the at least one foodstuff, and/or
the cooling state of the at least one foodstuff, in particular if frozen or cooled or at room temperature, and/or
the preparation state of the at least one foodstuff, in particular if raw or cooked.

The type of the at least one foodstuff specifies which foodstuff it is. In other words, it is possible to enter, by means of the central control unit, that a recipe and a cooking process are to be generated that e.g. comprise the foodstuffs “tomatoes” and “beef tenderloin”.

The ingredients of the foodstuff specify a constituting part of the foodstuff. The ingredients flour, salt, sugar, yeast, and milk are, for example, ingredients of the foodstuff “braided loaf”. The foodstuff can e.g. also be a vegetable mix, in which case the ingredients of the foodstuff are e.g. broccoli and tomatoes.

For the following explanations, it is emphasized that the term “entering”, such as in “entering an amount of a foodstuff to be cooked”, is to be understood as the transmittal of an information, such as the amount of a foodstuff stocked, via the input device to the central control unit. The term “entering” is not to be misunderstood as the “feeding of a foodstuff into the cooking device”, with the latter describing the insertion of the foodstuff into the cooking cavity for cooking it.

By entering the individual input parameters, the recipe can be identified and the identified recipe's cooking process can be generated in a more direct and dynamic manner. The entry of the type of the available foodstuffs and/or the foodstuff ingredients allows identifying a suitable recipe by means of which the available foodstuffs can be used.

By entering the amount of the at least one foodstuff, the central control unit can identify a recipe and generate a cooking process that take the available amounts into account. This results in a more suitable recipe and a better cooking result since it is adjusted to the amount to be cooked. For example, a recipe and a cooking process that have—by default—been designed for four persons, can be reduced to two persons because the amount of the available foodstuff would be insufficient for four persons. Further, when cooking meat, the cooking can be shorted for a smaller amount of the foodstuff. The central control unit can therefore optimize the cooking process in view of the available amount of the foodstuff.

The cooling state and/or the preparation state of a foodstuff can also influence the recipe or cooking process. For example, the central control unit can specify a longer cooking for a cooled foodstuff than for a foodstuff that is already at room temperature.

Advantageously, the at least one central control unit is adapted to generate at least one cooking process parameter, in particular specifying
with which one cooking device or with which cooking devices of several cooking devices the at least one foodstuff is to be cooked, and/or
with which one cooking elements (40-43, 46), in particular top heat (41), bottom heat (42), grill heater (41a), hot air generator (43), microwave generator (46), and/or steam generator (40), of the at least one cooking device the at least one foodstuff is to be cooked, and/or
with which cooking cavity state parameter, in particular with which temperature and/or humidity and/or microwave radiation power, the at least one foodstuff is to be cooked,
with which time-dependence of a cooking cavity state parameter, in particular with which time-dependence of the temperature and/or of a humidity and/or of a microwave radiation power, the at least one foodstuff is to be cooked, in particular wherein the time-dependence of the temperature and/or of the humidity and/or of the microwave radiation power is predefined and/or is controlled in a control loop, in particular using a measured foodstuff core temperature, and/or
how long the cooking process takes, and/or
which or which parts of the foodstuff(s) is/are to be inserted into which cooking device at what time.

A precise determination of said cooking process parameters is possible because accurate input parameters of the foodstuffs are available to the central control unit.

It is e.g. possible to specify, for the central control unit, which cooking devices are available in a household. Often, a baking oven, a steam-cooking appliance, and a microwave oven are available. The central cooking unit then decides by means of which cooking device the foodstuff is to be cooked, i.e. by means of the baking oven or the steam-cooking appliance. In addition, precise instructions regarding the use of the cooking elements can be transferred to the at least one cooking device.

In a preferred embodiment, the at least one cooking process parameter is adjusted to the use of the foodstuff in the recipe.

This exemplifies that the central control unit defines a cooking process that is especially well suited for the recipe tied to the cooking process. For example, there are different recipes where potatoes are used. Depending on the recipe, the potatoes need to have different texture. For example, the potatoes for a potato salad have to be prepared and cooked differently from the potatoes for a grilled potato or a foil-wrapped potato. By adjusting the cooking process parameters to the use of the foodstuff in the recipe, a good cooking result can be achieved.

In comparison to conventional methods, the following differences or advantages exist:
A cookbook also provides instructions for cooking, with the instructions adjusted to the recipe. However, these instructions have to be rudimentary because the user has to transfer them to the cooking device. In addition, a cookbook cannot take into account what cooking devices are available to the user.
If complex cooking processes are already programmed into a cooking device, it will still be unclear to the user if a given pre-programmed cooking process is suitable for a certain recipe at all because, for the same ingredients, different cooking processes may be required in different recipes.

An apparatus where the recipe and the cooking process are tied to each other in the described manner simplifies the user's operation and leads to a better cooking result.

Advantageously, the type of the at least one foodstuff and/or ingredients of the at least one foodstuff can be entered by means of an input device, and the identified recipe comprises the at least one type and/or the ingredients of the at least one foodstuff.

This ensures that at least one selected foodstuff and/or a selected ingredient of the foodstuff is present in the identified recipe.

Further, the central control unit can be adapted to access a database for identifying the recipe and the cooking process, in which database a plurality of recipes and cooking processes are stored, and in particular wherein a cooking process is attributed to each recipe.

Advantageously, the control unit generates the recipe and the cooking process
by choosing a recipe or by combining several recipes, and/or
by choosing a cooking process and/or by combining several cooking processes,

from the plurality of recipes and cooking processes stored in the database according to at least one selection criterion.

The database can be arranged externally, or it can be a part of the at least one cooking device.

In the simplest case, at least one selection criterion is used to select a recipe and a suitable cooking process. They are not modified further. It is, however, also possible for the central control unit to generate a single recipe and a single cooking process from several recipes and cooking processes.

For example, different recipes for preparing a meat dish and for preparing a side dish, e.g. cauliflower, may be available. These can e.g. be combined by the control unit in such a manner that the meat and the cauliflower are cooked in the same or in different cooking devices in such a manner that both foodstuffs are ready at the same time.

Advantageously, the selection criterion can comprise:
that the recipe comprises a highest number of foodstuffs and further ingredients of the at least one foodstuff and the further ingredients that have been entered in the input device, and/or
a user selection carried out on the input device, in particular a user selection from several recipes displayed on the output device, and/or
a maximum duration of the cooking process, and/or
the cooking devices that are available, in particular cooking elements that are available and/or
a valuation stored in the database, in particular a user valuation.

A “user selection” is to be understood as the user being able to choose from several possible recipes. The remaining selection criteria may e.g. be insufficient for the control unit to propose a single optimum recipe but, rather, several recipes are possible, one of which has to be selected by the user.

The selection criteria that relate to the cooking process, such as the maximum duration of the cooking process or the available cooking devices, are of relevance for selecting the recipe because the central control unit must only select recipes that comprise foodstuffs that can be cooked under the given selection criteria.

In other words, the selection criterion can comprise checking the cooking devices that are available, i.e. the control unit determines what cooking devices form part of the apparatus and makes the selection criterion dependent thereon.

Hence, in an advantageous embodiment, the central control unit is adapted and structured to

accessing a database storing a plurality of database recipes,

determining what cooking devices form part of said apparatus,

identifying, using at least one selection criterion, said identified recipe by at least one of
choosing a database recipe from said database,
combining several database recipes into the identified recipe,

wherein said selection criterion depends what cooking devices form part of said apparatus.

In that case, the control unit is advantageously adapted and structured to verify if a given database recipe is compatible with at least one of the cooking devices forming part of said apparatus and to exclude the given database recipe from becoming said identified recipe if the database recipe is not compatible with any of the cooking devices forming part of the apparatus.

In an advantageous embodiment, for combination of several cooking processes, the central control unit can be adapted to,
arranging the several cooking processes sequentially in the cooking process, and/or
transmitting the several cooking processes to different cooking devices, in particular to a baking oven and to a steam-cooking appliance, and/or
interpolating several cooking process parameters of cooking processes stored in the database.

A sequential arrangement of the several cooking processes stored in the database into a cooking process is possible if it is not necessary to finish cooking different foodstuffs at the same time. For example, potatoes for a potato salad can be cooked in a first step, wherein in a second step, while the cooked potatoes for the potato salad are portioned by the user, a meat loaf can be cooked in the cooking device.

The interpolation of cooking parameters is particularly useful if the recipes stored in the database are not compatible with the specified amounts of foodstuff. If, for example, the database stores only cooking processes for a beef tenderloin of 400 g and a beef tenderloin of 600 g, but only a beef tenderloin of 500 g is available, the cooking device can interpolate the cooking duration accordingly. In this manner, it can be estimated at what time a foodstuff has to be placed into the cooking cavity in order for it to be e.g. fully cooked at the same time as the other foodstuffs.

The problem mentioned above can, in a second aspect, also be solved by a method for operating the apparatus described above.

Accordingly, the method comprises the following steps:
the central control unit identifies, using the input parameters of the foodstuffs and the further ingredients, a recipe, and
the central control unit generates a cooking process for the recipe and transmits it to at least one cooking process control of the at least one cooking device.

Further, it is possible that the user has an electronic recipe available and that he instructs the input device to search the electronic recipe, in particular by means of a word search, for autonomously identifying the input parameters of the foodstuffs and the further ingredients in the recipe.

In a further aspect, the invention relates to an apparatus, in particular as described above, comprising
one or more cooking devices, wherein each cooking device comprises a cooking process control,
at least one input device adapted and structured to receive input parameters descriptive of at least one foodstuff and/or of at least one ingredient,
at least one output device,
at least one central control unit, wherein said central control unit is connected to said input and said output device and adapted and structured to carry out the steps of,
identifying, as a function of said input parameters, a recipe,
generating, for said recipe, a cooking process, and
transmitting said cooking process to the cooking process control of at least one of said cooking devices.

In yet another embodiment, the invention relates to a method, in particular as described above, for cooking a foodstuff, by means of an apparatus, in particular by means of the apparatus described above, wherein said apparatus comprises
one or more cooking devices, wherein each cooking device comprises a cooking process control,
at least one input device,
at least one output device,
at least one central control unit, wherein said method comprises the steps of
receiving, through said input device, input parameters descriptive of at least one foodstuff and/or of at least one ingredient,
identifying, by means of said central control unit as a function of said input parameters, a recipe,
generating, by means of said central control unit, a cooking process for said recipe,
transmitting said cooking process from said central control unit to the cooking process control of at least one of said cooking devices,
operating said at least one cooking device in accordance to said cooking process for cooking said foodstuff.

### BRIEF DESCRIPTION OF THE DRAWINGS

Further embodiments, advantages and applications of the invention are given in the dependent claims and in the now following description by reference to the figures, wherein:

FIG. 1 shows an apparatus with a central control unit and the components connected to it and

FIG. 2 shows a second embodiment of an apparatus for cooking foodstuffs.

### MODES FOR CARRYING OUT THE INVENTION

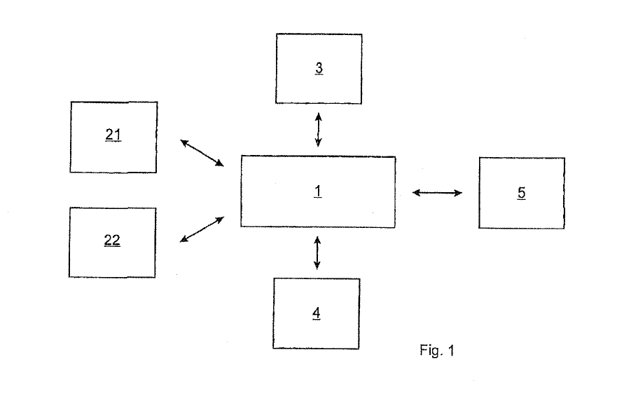

In FIG. 1, the individual components of the apparatus and their interactions are shown schematically. The central control unit 1 forms the center of the apparatus. It is, in the present case, connected to two cooking devices, a steam-cooking appliance 21 and a baking oven 22, with an input device 3, an output device 4, and a database 5.

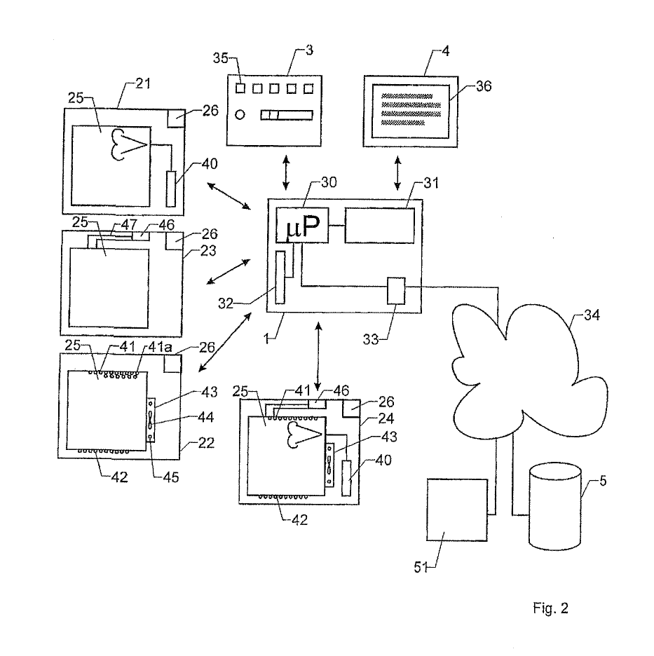

FIG. 2 shows a second, more detailed embodiment of an apparatus for cooking foodstuffs.

The apparatus again comprises a central control unit 1 having a microprocessor or microcontroller 30 connected to a memory device 31. Central control unit 1 further comprises a first interface circuit 32 for connecting it to the various cooking devices by means of wire-bound or wireless communication, as well as a second interface 33 for connecting it to a computer network 34, in particular a wide-area network, such as the internet.

Input device 3 comprises a plurality of user-operatable interface elements 35, such as button, nobs or sliders, and output device 4 comprises a display 36.

Input device 3 and output device 4 may also be formed by a single unit, such as a touchscreen device, in particular a tablet, smartphone or personal computer.

In the second embodiment, the cooking devices comprise a steam-cooking appliance 21, a baking oven 22, a microwave oven 23, and a combined cooking device 24.

Each of these devices comprises a cooking cavity 25 for receiving the foodstuff to be cooked, usually accessible through a door or lid (not shown), one or more cooking elements for feeding heat to the foodstuff, and a cooking process control 26 for controlling the cooking elements. Cooking process control 26 is equipped with an interface for communicating with central control unit 1 through interface circuit 32.

Steam-cooking appliance 21 comprises, as its cooking element, a steam generator 40 with a water reservoir and a heater for heating the water and feeding it to cavity 25 by means of one or more nozzles.

Baking oven 22 comprises several cooking elements, namely a top heat 41, a bottom heat 42, and a hot air generator 43. Top heat 41 and bottom heat 42 are resistive heating elements arranged at the top and bottom of cooking cavity 25. There may also be a grill heater 41a in addition to top heat 41. Hot air generator 43 comprises a fan 44 and a resistive heater 45 adapted and structured to withdraw air from cooking cavity 25, heat it, and blow it back into cooking cavity 25.

Microwave oven 23 comprises, as its cooking element, a microwave generator 46, such as a magnetron, coupled to cooking cavity 25 by means of a waveguide 47.

Combined cooking device 24 comprises, as its cooking elements, a combination of several of the cooking elements 40-47 mentioned above. In the example shown here, it comprises a steam generator 40, a top heat 41, a bottom heat 42, a hot air generator 43, and a microwave generator 47.

Further, in one embodiment the present invention also relates to central control unit 1 accessing an external database 5 via computer network 34. For example, database 5 can comprise one or more database servers containing database recipes. These can e.g. be recipes in a structured form, e.g. encoded in XML, or in natural language, e.g. encoded as text or HTML.

Finally, the system may also comprise a central server 51, accessible via computer network 34. Central server 51 may e.g. provide user feedback processing as described below.

In the shown embodiment, control unit 1 contains, in memory 31, suitable programming to execute the steps of the invention according to the present invention.

Control unit 1 can be a stand-alone device, or it can be integrated in one of the cooking devices 21-24.

Central control unit 1 can be arranged in the household where the cooking devices 21-24 are located, or it can be located off-site, i.e. it can be implemented in a remote server, in particular in central server 51, in which case interface 32 is advantageously designed to access the devices 21-24 through network 34.

The various elements of control unit 1 can also be arranged at differing sites, i.e. part of central control unit 1 can e.g. be built into one or more of the cooking devices 21-24, while another part is e.g. arranged at a remote location and operating as part of central server 51.

Input device 3 and/or output device 4 can communicate with central control unit 1 by means of direct connections, such as Bluetooth, dedicated wires or a wire-bound or wireless LAN-connection, or they can be communicating with central control unit 1 through network 34.

In an advantageous embodiment, input device 3 and output device 4 are implemented as a stand-alone device accessing central control unit 1 through network 34 and/or a TCP/IP connection. For example, such a stand-alone device can be a tablet, a smartphone or a laptop or desktop computer.

Output device 4 can also be a projection system, such as e.g. shown in WO2010026032.

The interaction of the various components is now described by reference to different examples.

### Beef Tenderloin:

The user wants to prepare a piece of beef tenderloin without further side dishes. By means of input device 3, he communicates that his recipe should have a beef tenderloin as an ingredient. The central control unit processes this information by searching for suitable recipes in database 5. It finds different recipes, in which the tenderloin is e.g. seasoned or cooked differently. On output device 4, the possible recipes can be displayed to the user. In view of the cooking process, it can e.g. be displayed to the user how long it would take.

The user now selects the suitable recipe by means of input device 3 and therefore also the suitable cooking process. After settling for the recipe to be used, the cooking process parameters specifying the cooking process are transferred to baking oven 22 because, according to the cooking process, a better cooking result for beef tenderloin can be achieved by means of baking oven 22 than by means of steam-cooking appliance 21.

The described procedure is a comparatively simple example. It could be expanded as follows:
The user enters, by means of input device 2, that his available piece of tenderloin has a weight of 450 g. Among the recipes and cooking processes for beef tenderloin found in the database, central control unit 1 selects those that match this selection criterion. If no recipe and no cooking process for beef tenderloin of a weight of 450 g are present, central control unit 1 selects the recipe and the cooking process that is most similar. If, for example, the database holds a recipe and cooking process for beef tenderloin of 400 g and for beef tenderloin of 600 g, it selects the recipe and cooking process for the beef tenderloin of 400 g because it best matches the selection criterion; or, in other words, because it is most similar to the result that the user wants. The selected cooking process, which is transferred to baking oven 22, comprises cooking process parameters for operating the cooking elements, e.g. the top heat, the bottom heat, or the cooking cavity temperature. The cooking process can also exactly define at which time and over what time span the cooking elements are to be operated and how.
The user may further specify that the beef tenderloin should be ready cooked in three hours. In this case, the central control unit would e.g. select a cooking process in which the cooking is controlled automatically by means of the foodstuff temperature, which is measured by means of a foodstuff temperature sensor, in order to make sure that the desired foodstuff temperature will be reached in three hours.
The user may further specify the desired cooking level of the meat, i.e. if it the meet is to be cooked “rare”, “medium”, or “done”. In this case, the control unit 1 may adjust the desired final foodstuff temperature accordingly to e.g. 53, 55, and 57° C., respectively.
   Bratwurst with Potatoes:

In a next example, the user enters the ingredients veal bratwurst and potatoes by means of input device 3. In this case, the central control unit finds, in database 5, several recipes (with cooking processes and the attributed cooking process parameters in parentheses):
A: Veal bratwurst (baking oven, 180° C., 10 min, use grill heater) with onion sauce and French fries (baking oven or steam-cooking appliance, 220° C., 30 min, use hot-air generator),
B: Veal bratwurst (baking oven, 180° C., 10 min, use grill heater) with potato gratin (baking oven or combined device, 180° C., 30 min, hot air generator, add steam if available),
C: Veal bratwurst (baking oven, 180° C., 10 min, use grill heater) with potato salad (baking oven or steam-cooking appliance, 100° C., 35 min, use hot water bath for potatoes in baking oven).
D: Veal bratwurst (baking oven, 180° C., 10 min, use grill heater) with whole potatoes (steam-cooking appliance, 100° C., 35 min).
The recipes can again be displayed on output device 4, the user can select a suitable recipe and an accompanying cooking process, and the respective cooking process is transmitted to the cooking devices.

If the apparatus e.g. comprises only one baking oven 22 but no steam-cooking appliance 21, recipe D cannot be prepared with the available baking-oven alone because the veal bratwurst and the whole potatoes have to be cooked simultaneously for them to be ready at the same time.

On the other hand, recipe C would be feasible because, in a first step, the potatoes for the potato salad can be cooked, and, in a second step, the veal bratwurst can be cooked while the potatoes cool and are cut for the salad.

For recipe B, again, two cooking devices are required because two foodstuffs have to be prepared. It would be possible, though, to insert both foodstuffs into the same cooking cavity.

Recipe A is also not suitable for being prepared with only one baking oven 22 because the French fries have to be prepared at a higher temperature than the veal bratwurst.

Hence, the central control unit dynamically selects, depending on the available cooking devices, the possible recipes and cooking processes.

Some variants of the described example are presented in the following:
If a steam-cooking appliance 21 as well as a baking oven 22 are available, the user can be offered all four recipes and the respective cooking processes for selection.
If the user enters further foodstuff parameters by means of input device 3, e.g. specifying the amounts of the foodstuffs available, the central control unit can again exclude individual recipes and cooking processes, e.g. those for which the stocked amounts of foodstuffs are insufficient.
If the user has further foodstuffs or further ingredients available and enters these through input device 3, e.g. onions and apples, the central control unit searches for recipes and cooking processes that also comprise the additional foodstuffs and the additional ingredients. Central control unit 1 therefore selects the recipe and the cooking process that comprises a highest count of the given foodstuffs and further ingredients. Hence, central control unit 1 selects recipe A because that one also comprises the ingredient onions. The central control unit recognizes the highest ingredient match in recipe A.
Control unit 1 may also display further messages to the user, such as where to place the foodstuff in the cooking cavity or what cooking vessel to use. For example, control unit 1 can display the message “place bratwurst on wire shelf into uppermost rib of cavity, with an aluminum-covered tray below it to catch juices” on output device 4 or on a display of the respective cooking device. Such a user message may be stored in the database recipe, or control unit 1 may add it.

### Braided Loaf:

As a further example, the preparation of the foodstuff “braided loaf” is explained. In this case, the foodstuff ingredients flour, salt, yeast, sugar, butter, milk, etc. are required, by means of which the foodstuff “braided loaf” is prepared prior to cooking. In this case, the braided loaf is to be cooked in baking oven 22. First, the user enters, by means of input device 3, the foodstuff “braided loaf” and/or the foodstuff ingredients. In order to find a suitable cooking process, the central control can, on the one hand, search for the type of the foodstuff, namely the braided loaf, but on the other hand also for the foodstuff ingredients in the database. This is of particular advantage if recipes and cooking processes of international databases are accessed, where the foodstuff may not be called a braided loaf. In this manner, suitable cooking processes can be found, which can be transferred to the baking oven by means of the central control unit.

### Vegetable Mix:

If the foodstuff to be cooked is e.g. a vegetable mix, it is possible that there is, in the database, no suitable cooking process designed for exactly this mixture of vegetables. Hence, for dynamically generating the cooking process, in this case the foodstuff ingredients, such as tomatoes and broccoli, are to be entered into input device 3 as well and to be taken into account. Then, a cooking process optimized for the present ingredients in the vegetable mix is to be transferred to the at least one cooking device.

### Recipe Information:

As described above, central control unit 1 is adapted and structured to identify a recipe and, therefrom, to generate a cooking process.

In one embodiment, the recipe is a data record containing user instructions intended for the user of the apparatus and instructing him how to prepare the foodstuff.

In addition, the recipe's data record may contain additional processing information, such as the cooking process.

For example, for the case of a braided loaf, the recipe may contain information as follows
A) the type of the foodstuff:
   type: braided loaf
   category: bread
B) the ingredients of the foodstuff for a given quantity:
   quantity: serves four
   ingredient 1: 500 g of wheat flour
   ingredient 2: 0.75 tea spoons of salt
   ingredient 3: 20 g of yeast
   ingredient 4: 60 g of butter
   ingredient 5: 3 dl of milk
   ingredient 6: 1 egg white
   ingredient 7: 1 table spoon of milk
C) the instructions to the user:
   Mix ingredients 1 through 5. Knead to prepare a dough. Let dough rest for one hour. Knead again. Divide the dough into three parts and form a braid (for information on forming a braid, see <the recipe may contain a hyperlink to more detailed instructions here>). Place braid on baking sheet and let it rise again for 30 minutes. Mix ingredients 6 and 7 and apply resulting liquid to braid's surface. Insert into oven.
D) the generic process information:
   appliance to use: baking oven
   pre-heat: to 200° C.
   prompt user: “insert braided loaf”
   maintain temperature: at 200° C. for 35 minutes
   switch off oven
   prompt user: “remove braided loaf”.

As mentioned above, this type of information may be present in structured form in database 5, or a human-reasonable recipe may be searched (parsed) to generate this type of information.

The category of the foodstuff may also be determined by control unit 1 from the type of the foodstuff, e.g. using suitable lookup tables, instead of it being specified explicitly in the record.

When the user selects this recipe, central control unit 1 will identify it as the recipe to be used and will display the ingredients under B as well as the instructions under C on display device 4.

Further, central control unit 1 can generate the cooking process by directly using the generic process information D above as cooking process parameters.

### Quantitative Adaptation:

If the user has specified that he wants prepare a different amount of the foodstuff, e.g. by entering that he wants to use 750 g of flour or that he wants to make a loaf that serves six, the list B of ingredients will be automatically scaled before being displayed on display device 4. Similarly, the cooking process may have to be adapted.

Adapting the cooking process to a given amount of foodstuff can be carried out by means of the methods described above, such as interpolation if database recipes for different amounts of the foodstuff are available.

Alternatively or in addition thereo, the information under point D above may contain additional parameters describing how the individual steps have to be varied as a function of foodstuff quantity.

In yet another embodiment, the type of the foodstuff can be used by central control unit 1 in order to scale the cooking process to different amounts. For example, in the present example, the foodstuff type is “bread”. Control unit 1 may contain scaling information, in memory 31, or access such information in database 5, describing how to scale cooking process parameters of bread with quantity, e.g. by specifying that the cooking duration is to be calculated from

t=t0*(1+0.05*(M−M0)/M0),

with t being the cooking duration to be used, t0 being the cooking duration in the cooking process specified in the database recipe, M being the amount of flour in the foodstuff, M0 being the amount of flour in the database recipe. All other parameters of the cooking process attributed to the database recipe are to remain unchanged.

The scaling information used by central control unit 1 may contain further information, such as limits for which the scaling is applicable, e.g. in the above example, that the scaling is applicable for (M−M0)/M0 being between 0.2 and 5 and/or for M between 100 g and 2000 g—if these limits are exceeded, process control unit 1 may advise the user that no suitable recipe can be found.

### Device Adaptation:

In yet another embodiment, central control unit 1 can be adapted and structured to adapt the cooking process to device-specific parameters of the cooking device 21-24 to be used.

This is a useful tool for improving the cooking process in view of a specific device type, thereby optimizing the cooking results.

For this purpose, control unit 1 executes the following steps executed in any possible order:
1) Control unit 1 determines (optionally based on a user's selection) the cooking device to be used, as described above.
2) Control unit 1 retrieves generic process information. This generic process information advantageously describes a cooking process as it is likely to work in most cooking devices. For example, it consists the process steps found in a regular cookbook or specified as item D in section “Recipe information” above.
3) Control unit 1 retrieves “process adaptation information” about the cooking device to be used. Such process adaptation information may e.g. contain the information that, for a given foodstuff type, a given one of several possible device settings should be used and/or that temperatures and/or process durations should be increased or decreased by a specified amount (e.g. by 10%).
4) Control unit 1 processes the generic process information in order to generate a device-specific cooking process.
For example, a cooking device manufacturer manufactures a baking oven 22 and has found that foodstuff in general, or at least foodstuff of the category “bread”, is best cooked using hot-air generator 43 instead of top heat 41 and bottom heat 42 because this allows a faster processing time at a lower temperature.
In that case, the process adaptation information for that specific device may e.g. contain the following information:
A) Reduce generic cooking time by 10%
B) Use hot-air generator instead of top heat 41 and bottom heat 42.
In that case, when this specific baking oven is to be used for processing the braided loaf of the example above, the generic process information (item D of the recipe information) will be modified as follows for generating the cooking process (modifications underlined):
pre-heat: to 180° C. using hot-air generator
prompt user: “insert braided loaf”
maintain temperature: at 180° C. for 28 minutes using hot-air generator
switch off oven
prompt user: “remove braided loaf”.
In another example, a manufacturer may build a combined device 24 that contains a steam generator 40 as well as a hot-air generator 23 and has found that foodstuff of category “bread” is best processed by activating steam generator 40 in the first 10 minutes of the process (instead of a pre-heating step) and using hot air generator 43 during the whole baking process. Also, in that case, a surface treatment of the loaf prior to baking (such as applying a mixture of egg and milk to it) is not required.

In that case, the process adaptation information for that specific device may e.g. contain the following information:
A) Reduce generic cooking time by 10%.
B) Use hot-air generator instead of top heat 41 and bottom heat 42.
C) Activate the steam generator during the first 10 minutes of the process.
D) Do not pre-heat.
E) Tell user before process: “fill water into steam generator”
F) Tell user before preparation: “do not apply surface treatment to the loaf”

In that case, when this combined device is to be used for processing the braided loaf of the example above, the generic process information (item D of the recipe information) will be modified as follows for generating the cooking process (modifications underlined):
prompt user: “fill water into steam generator”.
prompt user: “insert braided loaf”
pre-heat: none
activate steam generator for 10 minutes and, at the same time,
switch on hot-air generator, heat up to and maintain temperature at 180° C. for 28 minutes
switch off oven
prompt user: “remove braided loaf”.

This information is sent in the form of the cooking process parameters to combined cooking device 24.

In addition, the user will be advised (on display device 4 or a display of the combined device 24) not to apply surface treatment to the loaf.

Hence, in more general terms, the following steps can be carried out:
a) derive, from the identified recipe, generic process information descriptive of the cooking process,
b) retrieve process adaptation information specific to the cooking device to that is to be used for cooking the foodstuff,
c) modify the generic process information depending on the process adaptation information in order to generate the cooking process.

These steps can be carried out in any possible order.

The steps are typically carried out by control unit 1. Alternatively, one or more of the steps can be carried out by process control 26 of the cooking device to be used.

The step of modifying the generic process information in particular comprises at least one of
modifying a cooking duration of the generic process information,
modifying a cooking temperature of the generic process information,
adding instructions for using specific heating elements 40-47 of the cooking device 21-24 to be used for cooking the foodstuff.

Further, the process adaptation information can also comprise at least one user message, as shown in the example above, and control unit 1 can cause this message to be displayed to the user on output device 4 and/or on a display of the cooking device to be used.

In particular, such a message can comprise instructions to
use a specific cooking device,
add water to a specific cooking device,
use a special receptacle for the foodstuff,
use a specific location within the device's cavity 25 for cooking the foodstuff in the cooking device, and/or
add, modify or omit certain steps in the preparation of the foodstuff.

The additional step of “modify the generic process information depending on the process adaptation information” not only has its advantages in obtaining an optimum cooking result on a given cooking device. It can also be used to adapt the recipe to a specific device if there are several, not identical cooking devices.

For example, if a user wants to prepare a bread (such as the braided loaf described above), control unit 1 can test which of the present cooking devices can be used for baking the bread. In the example of FIG. 2, possible devices are the baking oven 22 and the combined cooking device 24.

Control unit 1 will display, on display device 4, a list of the devices that can be used for baking the bread and prompt the user to select one of them. Alternatively, control unit 1 can make this selection autonomously, e.g. depending on other foodstuffs that are to be cooked at the same time.

Once the device to be used has been selected, the generic process information is adapted according to the process adaptation information of the selected device, and the cooking process as well as the cooking process parameters are generated therefrom.

The “process adaptation information” can be stored in memory 31 of control unit 1, or in the individual cooking devices 21-24, or on database 5, or on server 51.

### User Feedback:

As already mentioned, database 5 can comprise valuation for certain recipes. This valuation can e.g. be descriptive of the users' satisfaction with the given recipe. It can e.g. be used when identifying a database recipe to be applied.

In addition, control unit 1 can be adapted and structured to receive feedback from the user using the present apparatus.

For example, the user can operate input device 3 after having used a given recipe in order to specify his satisfaction with the result.

In this case, control unit 1 may also prompt the user for further details, in particular if the user has indicated to be unsatisfied with the result of the cooking.

For example, control unit 1 can be adapted and structured to display, to the user, a plurality of quality criteria, for each of which the user can specify his satisfaction.

For example, the quality criteria may comprise at least one of the following criteria for the cooked foodstuff: degree of cooking, taste, humidity content.

The criteria the user is prompted for may depend on the type or category of the foodstuff. For example, when the foodstuff category was “bread”, the user may be prompted for the crispness of the bread's crust after cooking (too soft, okay, too crisp). If the foodstuff type was pizza margherita, the user may be prompted for the humidity of the filling, the melting degree of the cheese and/or the texture of the base.

Such feedback can be transmitted by control unit 1 to central server 51 for processing. The feedback can then be used for improving the programming of central unit 1 and/or of the process adaptation information described above and/or for improving at least part of the recipes in database 5.

Hence, the invention also relates to a method comprising the steps of
upon completion of a cooking process, prompting a user for feedback on a result of the cooking process (such prompting may either be automatic or invoked by the user selecting a feedback option in the user interface),
receiving said feedback from said user.

The method may further comprise the additional step of transferring said feedback to the central server 51. This is especially useful if control unit 1 is not implemented in server 51.

Alternatively, or in addition thereto, method may further comprise the step of using said feedback to modify at least one of the recipes in database 5.

### Notes:

As mentioned above, a “combined cooking device” is a cooking device equipped for several cooking methods. For example, a combined cooking device is able cook a foodstuff simultaneously by means of microwave radiation and steam. Advantageously, a combined cooking device comprises at least two of the following three cooking elements for heating the foodstuff: (1) top and bottom heating and hot air heating, (2) a microwave generator, (3) a steam generator.

While the present application describes preferred embodiments of the invention, it is to be distinctly understood that the invention is not limited thereto and can also carried out in other manner within the scope of the following claims.

What is claimed is:

1. An apparatus comprising:
one or more cooking devices, wherein each cooking device comprises a cooking process control,
at least one input device adapted and structured to receive input parameters descriptive of at least one foodstuff and/or of at least one ingredient,
at least one output device,
at least one central control unit, wherein said central control unit is connected to said input and said output devices and adapted and structured to carry out the steps of,
identifying, as a function of said input parameters, a recipe,
generating, for said recipe, a cooking process, and
transmitting said cooking process to the cooking process control of at least one of said cooking devices.

2. The apparatus of claim 1 wherein the input parameters of the at least one foodstuff comprise
a type of the at least one foodstuff and/or
ingredients of the at least one foodstuff and/or
an amount of the at least one foodstuff, in particular a weight and/or a volume and/or a count of the at least one foodstuff, and/or
a cooling state of the at least one foodstuff, in particular indicative of the foodstuff to be frozen or cooled or at room temperature, and/or
a preparation state of the at least one foodstuff, in particular indicative of the foodstuff being raw or cooked.

3. The apparatus of claim 1 wherein the at least one central control unit is adapted to define at least one cooking process parameter, in particular indicative of
with which cooking device or with which cooking devices of several cooking devices the at least one foodstuff is to be cooked, and/or
with which cooking elements, in particular a top heat, a bottom heat, a grill heater, a circulating air heater, a microwave generator, or a steam generator, of the at least one cooking device the at least one foodstuff is to be cooked, and/or
with which cooking cavity state parameter, in particular a temperature and/or a humidity and/or a microwave radiation power, the at least one foodstuff is to be cooked,
with which time-dependence of a cooking cavity state parameter, in particular of a temperature and/or of a humidity and/or of a microwave radiation power, the at least one foodstuff is to be cooked, in particular wherein the time-dependence of the temperature and/or of the humidity and/or of the microwave radiation power is predefined and/or controlled in a control loop, in particular using a measured foodstuff core temperature, and/or
how long the cooking process takes, and/or
which or which parts of the foodstuff(s) is/are to be inserted into which cooking device at what time.

4. The apparatus of claim 1 adapted to allow entry of a type of the at least one foodstuff and/or ingredients of the at least one foodstuff by means of the input device, and the identified recipe comprises the at least one type and/or the ingredients of the at least one foodstuff.

5. The apparatus of claim 1 wherein the central control unit is adapted to access a database for identifying the recipe and the cooking process, in which database a plurality of recipes and cooking processes are stored,
in particular wherein a cooking processes is attributed to each recipe.

6. The apparatus of claim 5 wherein the central control unit is adapted to identify the recipe and/or to generate, by applying at least one selection criterion, the cooking process
by choosing a recipe or by combining several recipes into a combined recipe, and/or
by choosing a cooking process and/or by combining several cooking processes into a combined cooking process,
from the plurality of recipes and cooking processes stored in the database.

7. The apparatus of the claim 4 wherein the at least one selection criterion comprises at least one of the following criteria:
that the recipe comprises a highest number of foodstuffs and further ingredients of the at least one foodstuff and the further ingredients that have been entered in the input device, and/or
a user selection carried out on the input device, in particular a user selection from several recipes displayed on the output device, and/or
a maximum duration of the cooking process, and/or
a valuation stored in the database, in particular a user valuation.

8. The apparatus of claim 6 wherein the at least one selection criterion comprises checking for the cooking devices that are available, in particular checking for the cooking elements that are available.

9. The apparatus of claim 1 wherein the identified recipe is output by means of the output device.

10. (canceled)

11. The apparatus of claim 1 wherein the central control unit is adapted and structured to
accessing a database storing a plurality of database recipes,
determining what cooking devices form part of said apparatus,
identifying, using at least one selection criterion, said identified recipe by at least one of
choosing a database recipe from said database,
combining several database recipes into the identified recipe,
wherein said selection criterion depends what cooking devices form part of said apparatus.

12. The apparatus of claim 11 wherein said control unit is adapted and structured to verify if a given database recipe is compatible with at least one of the cooking devices forming part of said apparatus and to exclude the given database recipe from becoming said identified recipe if said database recipe is not compatible with any of the cooking devices forming part of said apparatus.

13. The apparatus of claim 1 wherein the central control unit is adapted and structured to
deriving, from the identified recipe, generic process information descriptive of the cooking process,
retrieving process adaptation information specific to the cooking device to be used for cooking the foodstuff, and
modifying the generic process information depending on the process adaptation information in order to generate the cooking process.

14. The apparatus of claim 13 wherein the central control unit is adapted and structured to modify the generic process information by at least one of
modifying a cooking duration of the generic process information,
modifying a cooking temperature of the generic process information,
adding instructions for using specific heating elements of the cooking device to be used for cooking the foodstuff.

15. The apparatus of claim 11 wherein said process adaptation information comprises at least one user message and wherein said control unit is adapted and structured to display said user message.

16. The apparatus of claim 1 wherein said at least one cooking device is at least one of a baking oven, a steam-cooking appliance, a microwave oven, or a combined cooking device.

17. A method for cooking a foodstuff by means of an apparatus, wherein said apparatus comprises
one or more cooking devices, wherein each cooking device comprises a cooking process control,
at least one input device,
at least one output device,
at least one central control unit,
wherein said method comprises the steps of
receiving, through said input device, input parameters descriptive of at least one foodstuff and/or of at least one ingredient,
identifying, by means of said central control unit as a function of said input parameters, a recipe,
generating, by means of said central control unit, a cooking process for said identified recipe,
transmitting said cooking process from said central control unit to the cooking process control of at least one of said cooking devices,
operating said at least one cooking device in accordance to said cooking process for cooking said foodstuff.

18. The method of claim 17 wherein the central control unit defines, as part of the cooking process,
by means of which cooking elements, in particular top heat, bottom heat, grill heater, hot air generator, microwave, and/or steam generator, of the at least one cooking device the at least one foodstuff is to be cooked, and/or
by means of which cooking cavity state parameter, in particular temperature and/or humidity and/or microwave radiation power, the at least one foodstuff is to be cooked,
by means of which time-dependence of a cooking cavity state parameter, in particular by means of which time-dependence of a temperature and/or of a humidity and/or of a microwave radiation power, the at least one foodstuff is to be cooked, in particular wherein the time-dependence of the temperature and/or of the humidity and/or of the microwave radiation power is predefined and/or controlled in a control loop, in particular using a measured foodstuff core temperature, and/or
how long the cooking process takes, and/or
which foodstuff or which parts of the foodstuff(s) is to be inserted into the cooking device at what time.

19. The method of claim 17 wherein the central control unit adapted as structured to define, as part of the cooking process, by means of which cooking device or cooking devices of a plurality of cooking devices the at least one foodstuff is to be cooked.

20. The method of claim 17 wherein,
the central control unit accesses a database for generating the recipe and the cooking process, in which database a plurality of recipes and cooking processes are stored, in particular wherein one of the cooking processes is attributed to each recipe, and
the central control unit generates the recipe and the cooking process by selecting a recipe and/or by combining several recipes as a combined recipe, and/or by choosing a cooking process or by combining several cooking processes as a combined cooking process, according to a selection criterion from the plurality of recipes and cooking processes stored in the database.

21. The method of claim 20 wherein, when combining several cooking processes stored in the database into a combined cooking process,
the central control unit arranges the cooking processes sequentially in the combined cooking process, and/or
the central control unit transmits the several cooking processes to different cooking devices, in particular to a baking oven and/or to a steam-cooking appliance and/or to a microwave oven, and/or
interpolates cooking process parameters of several cooking processes stored in the database.

22. The method of claim 17 wherein the input device searches an electronic recipe, in particular by means of a word search, for finding the input parameters of the foodstuffs and the further ingredients in the recipe.

23. (canceled)

24. The method of claim 17 further comprising the steps of
accessing, by means of said central control unit, a database storing a plurality of database recipes,
determining, by means of said central control unit, the cooking devices forming part of said apparatus,
identifying, by means of said central control unit and using at least one selection criterion, said identified recipe by at least one of
choosing a database recipe from said database,
combining several database recipes into the identified recipe,
wherein said selection criterion depends the cooking devices forming part of said apparatus.

25. The method of claim 24 further comprising the step of verifying if a given database recipe is compatible with at least one of the cooking devices forming part of said apparatus and excluding the given database recipe from becoming said identified recipe if the given database recipe is not compatible.

26. The method of claim 17 further comprising the steps of
deriving, from the identified recipe, generic process information descriptive of the cooking process,
retrieving process adaptation information specific to the cooking device to be used for cooking the foodstuff, and
modifying the generic process information depending on the process adaptation information in order to generate the cooking process.

27. The method of claim 26 wherein the step of modifying the generic process information comprises at least one of
modifying a cooking duration of the generic process information,
modifying a cooking temperature of the generic process information,
adding instructions for using specific heating elements for the cooking device to be used for cooking the foodstuff.

28. The method of claim 26, wherein said process adaptation information comprises at least one user message and wherein said method comprises the step of displaying said user message to a user.

29. The method of claim 17 comprising the steps of
upon completion of a cooking process, prompting a user for feedback on a result of the cooking process, and
receiving said feedback from said user, and in particular
transferring said feedback to a central server.
